(19) United States
(12) Patent Application Publication
(10) Pub. No.: US 2015/0026772 A1
(43) Pub. Date: Jan. 22, 2015

(54) MEDIA BASED AUTHENTICATION AND AUTHORIZATION FOR SECURE SERVICES

(71) Applicant: Samsung Electronics Co., Ltd., Suwon (KR)

(72) Inventor: Sanjeev Verma, San Jose, CA (US)

(21) Appl. No.: 13/943,712

(22) Filed: Jul. 16, 2013

(51) Int. Cl. H04L 29/06

(52) U.S. Cl. CPC H04L 63/0884; H04L 63/0853
USPC 726/4

(57) ABSTRACT

A method requests authentication of an electronic device by a service provider in response to a request for service by the electronic device. An authentication element is provided to the service provider via a secure media of the electronic device. In response to the request for service, an authorization server provides proxy authorization for the service provider by receiving an authorization element from the service provider and installing the authorization element on the secure media. Upon authenticating and authorizing the electronic device using the secure media, accessing the requested service.

### TECHNICAL FIELD

One or more embodiments generally relate to centralized authentication and authorization for access to services, in particular, to a secure media for electronic devices for authentication and authorization for obtaining access to cloud based services.

### BACKGROUND

Cloud based eco-systems are increasingly becoming popular to provide a wide range of services, such as content distribution, mobile finance and eHealth. Many of these new cloud-based services are or will be available in mobile devices. In order for a mobile device to access these services, the device must be first authenticated by the eco-system before an authorization token is issued to the user of the device. The device user presents the authentication and authorization tokens to the cloud service provider every time he/she needs to access the subscribed service.

Cloud based eco-systems may be a closed monolithic eco-system that provides all services under a single umbrella or another type of eco-system where a number of closed cloud based eco-systems exist that provide specific services. In the former case, a single eco-system provides all kinds of secure services under a single umbrella and, hence the same authentication/authorization infrastructure can be used to meet the authentication/authorization requirements of a wide-range of services. In the latter case, devices obtain cloud based secure services from other eco-systems. This means that a device user must authenticate and obtain authorization tokens from a number of closed cloud-based eco-systems. This can lead to complicated design of devices since a single device needs to become authenticated with a number of eco-systems deploying different types of authentication mechanisms.

### SUMMARY

One or more embodiments generally relate to authenticating and authorizing an electronic device using secure media. In one embodiment, a method requests authentication of an electronic device by a service provider in response to a request for service by the electronic device. In one embodiment, an authentication element is provided to the service provider via a secure media of the electronic device. In one embodiment, in response to the request for service, an authorization server provides proxy authorization for the service provider by receiving an authorization element from the service provider and installing the authorization element on the secure media. In one embodiment, upon authenticating and authorizing the electronic device using the secure media, accessing the requested service.

In one embodiment, a system comprises an electronic device, a secure media device coupled to the electronic device, and an authorization server coupled to a plurality of cloud based service providers. In one embodiment, the authorization server provides proxy authorization for a requested service from one of the service providers by receiving an authorization token from the service provider and installing the authorization token on the secure media. In one embodiment, upon the selected service provider authenticating and authorizing the electronic device, the electronic device accesses the requested service.

In one embodiment a non-transitory computer-readable medium having instructions which when executed on a computer perform a method comprises requesting authentication of the electronic device by a service provider in response to a request for service by the electronic device. In one embodiment, an authentication token is provided to the service provider via a secure media of the electronic device. In one embodiment, in response to the request for service, an authorization server provides proxy authorization for the service provider by receiving an authorization token from the service provider and installing the authorization token on the secure media. In one embodiment, upon authenticating and authorizing the electronic device using the secure media, accessing the requested service.

In one embodiment, a method comprises providing an authentication token to a service provider from a secure media of an electronic device. In one embodiment, proxy authorization is provided for the service provider by an authorization server that receives an authorization token from the service provider and installs the authorization token on the secure media. In one embodiment, the authentication token and the authorization token from the secure media are used for accessing a requested service.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture system including authentication and authorization using a secure media, according to an embodiment.

FIG. 3 shows an example of a host certificate for a secure media, according to an embodiment.

FIG. 4 shows a block diagram of a cloud based system, according to an embodiment.

FIG. 5 shows a flow diagram of installation of an authentication element in a secure media, according to an embodiment.

FIG. 6 shows a flow diagram of service authentication using a secure media, according to an embodiment.

FIG. 7 shows a flow diagram of installation of an authorization token using a secure media, according to an embodiment.

FIG. 8 shows a block diagram of installation of credentials for cloud service providers in a secure media, according to an embodiment.

FIG. 9 shows a flowchart of credential installation by an authorization server to secure media, according to an embodiment.

FIG. 10 is a high-level block diagram showing an information processing system comprising a computing system implementing an embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments generally relate to authenticating and authorizing an electronic device using secure media. In one embodiment, a method requests authentication of an electronic device by a service provider in response to a request for service by the electronic device. In one embodiment, an authentication element is provided to the service provider via a secure media of the electronic device. In one embodiment, in response to the request for service, an authorization server provides proxy authorization for the service provider by receiving an authorization element from the service provider and installing the authorization element on the secure media. In one embodiment, upon authenticating and authorizing the electronic device using the secure media, accessing the requested service.

In one embodiment, a system comprises an electronic device, a secure media device coupled to the electronic device, and an authorization server coupled to a plurality of cloud based service providers. In one embodiment, the authorization server provides proxy authorization for a requested service from one of the service providers by receiving an authorization token from the service provider and installing the authorization token on the secure media. In one embodiment, upon the selected service provider authenticating and authorizing the electronic device, the electronic device accesses the requested service.

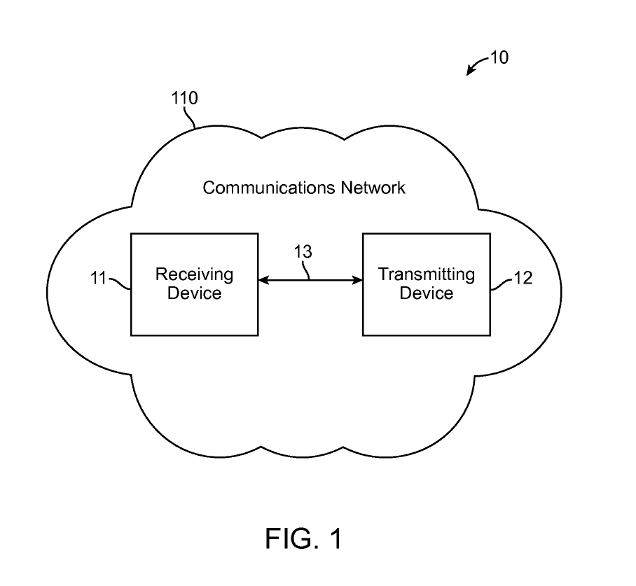

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a mobile telephone devices, television systems, cameras, camcorders, a device with audio video capabilities, tablets, wearable devices, and any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

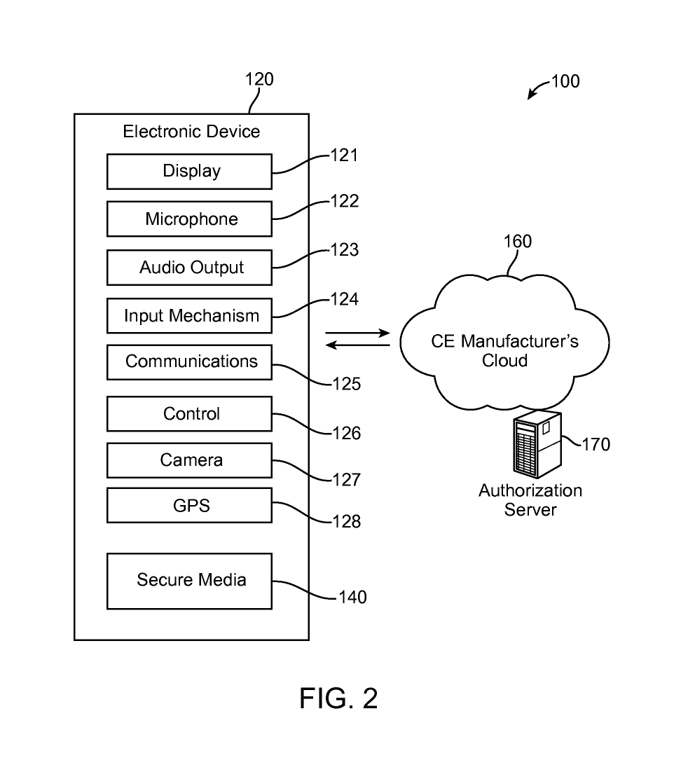

FIG. 2 shows a functional block diagram of an architecture system 100 that may be used for authentication and authorization of an electronic device 120, according to an embodiment. Both transmitting device 12 and receiving device 11 may include some or all of the features of electronics device 120. In one embodiment, the electronic device 120 may comprise a display 121, a microphone 122, audio output 123, input mechanism 124, communications circuitry 125, control circuitry 126, camera module 127, a GPS module 128 and a secure media device 140, and any other suitable components. In one embodiment, authentication and authorization credentials (e.g., tokens, security assertion markup language (SAML) assertions, etc.) are provided to the secure media 140 by an authorization server 170 of a cloud environment 160 (e.g., a CE Manufacturer cloud, cloud hub, etc.).

In one embodiment, all of the applications employed by audio output 123, display 121, input mechanism 124, communications circuitry 125 and microphone 122 may be interconnected and managed by control circuitry 126. In one example, a hand held music/video player capable of transmitting music/video to other tuning devices may be incorporated into the electronics device 120.

In one embodiment, audio output 123 may include any suitable audio component for providing audio to the user of electronics device 120. For example, audio output 123 may include one or more speakers (e.g., mono or stereo speakers) built into electronics device 120. In some embodiments, audio output 123 may include an audio component that is remotely coupled to electronics device 120. For example, audio output 123 may include a headset, headphones or earbuds that may be coupled to communications device with a wire (e.g., coupled to electronics device 120 with a jack) or wirelessly (e.g., Bluetooth® headphones or a Bluetooth® headset).

In one embodiment, display 121 may include any suitable screen or projection system for providing a display visible to the user. For example, display 121 may include a screen (e.g., an LCD screen) that is incorporated in electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app), social networking applications (e.g., Facebook®, Twitter®, Etc.), an Internet browsing application, etc. In some embodiments, the electronics device 120 may include one or several applications operative to perform communications operations. For example, the electronics device 120 may include a messaging application, a mail application, a voicemail application, an instant messaging application (e.g., for chatting), a videoconferencing application, a fax application, or any other suitable application for performing any suitable communications operation.

In some embodiments, the electronics device 120 may include microphone 122. For example, electronics device 120 may include microphone 122 to allow the user to transmit audio (e.g., voice audio) for speech control and navigation of applications 1-N 127, during a communications operation or as a means of establishing a communications operation or as an alternate to using a physical user interface. Microphone 122 may be incorporated in electronics device 120, or may be remotely coupled to the electronics device 120. For example, microphone 122 may be incorporated in wired headphones, microphone 122 may be incorporated in a wireless headset, may be incorporated in a remote control device, etc.

In one embodiment, the camera module 127 comprises a camera device that includes functionality for capturing still and video images, editing functionality, communication interoperability for sending, sharing, etc. photos/videos, etc.

In one embodiment, the electronics device 120 may include any other component suitable for performing a communications operation. For example, the electronics device 120 may include a power supply, ports or interfaces for coupling to a host device, a secondary input mechanism (e.g., an ON/OFF switch), or any other suitable component.

In one embodiment, the electronic device uses the secure media 140 in connection with cloud-hub based security mechanisms for entities that do not have their own closed monolithic eco-system providing all services. The cloud-hub provides a centralized authentication/authorization service to other cloud based eco-systems. In one embodiment, the secure media device 140 may be embedded (e.g., memory device) in the electronic device 120 or be removable from the electronic device 120 (e.g., a removable card, removable memory device, etc.). In one embodiment, the secure media 140 acts/provides one or more security tokens for storing all the credentials that an electronic device 120 user needs to access various cloud based services offered by different eco-systems. In one embodiment, two host devices interact with the secure media 140 through secure authentication channels (SACs), a local host (e.g., the electronic device 120) that can only read stored credentials from the secure media 140, and a remote host (e.g., the authorization server 170) that installs authentication/authorization elements (e.g., tokens) in the secure media 140. The idea here is to store authentication and authorization tokens locally in the secure media instead of interacting every time with the cloud hosted authentication and authorization servers. The client device can retrieve the credential from the local secure media instead of requesting a cloud hosted server for the Authentication/Authorization tokens every time a service is needed.

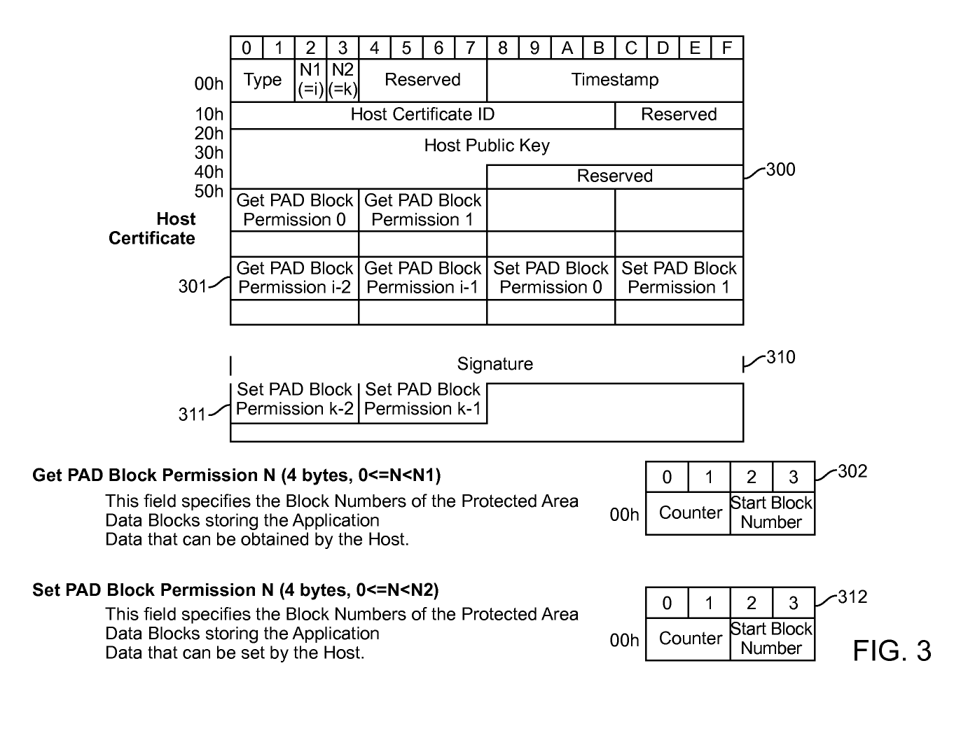

FIG. 3 shows an example of a host (e.g., authorization server 170) certificate 300 for the secure media 140, according to an embodiment. In one embodiment, the certificate 300 includes fields for protected area data (PAD) blocks in a host public key portion comprising Get PAD blocks 301, and fields for PAD blocks in a signature portion, such as Set PAD blocks 311. In one embodiment, the Get PAD blocks 301 comprise readable fields and the Set PAD blocks 311 comprise writeable fields. In one embodiment, Get PAD blocks 301 have field format 302, and Set PAD blocks 311 have field format 312. In one embodiment, the PAD blocks are protected against corruption from extraneous characters.

In one embodiment, the certificate 300 has access to a set of PAD blocks (indicated by the Counter value) in the secure media 140 starting from the start block number. The electronic device 120 is another host (local Host) that is given access the same set of blocks of the certificate 300. In one embodiment, electronic devices 120 are given only read access through only Get PAD block 301 permission. Table 1 shows a credential assignment table that managed by the authorization server 170.

TABLE 1

| | | Authentication/ |
|---|---|---|
| | | Authorization |
| PAD Number | Issuer | Token |
| Start Block Number | DECE | Authorization |
| Start Block Number + 1 | Visa | Authorization |
| — | — | — |
| Start Block Number + counter-1 | Device Manufacturer | Authentication |
| | Signature of the | |
| | Authorization Server | |

Since the authorization server 170 (e.g., remote Host) is responsible for the management of the credentials in the secure media 140, the authorization server 170 knows exactly where particular credentials are stored in the secure media 140. In one embodiment, the authorization server 170 maintains a local table (the credential assignment table) that keeps track of the locations (PAD Blocks assignment) of the credentials in the secure media 140. The credential assignment table is updated whenever the authorization server 170 installs/updates or deletes a credential on the secure media 140. In one embodiment, the authorization server 170 also shares this table with the electronic device 120 (e.g., local Host) so that the electronic device 120 knows the exact location of a particular credential in the secure media 140. In one embodiment, the credential assignment table is signed by the authorization server 170 for integrity protection.

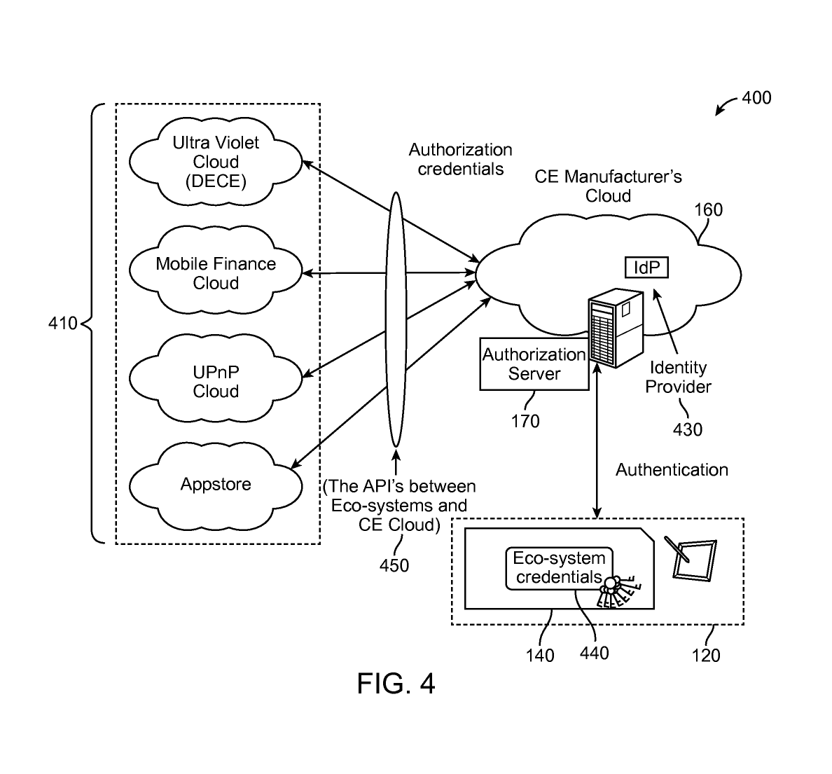

FIG. 4 shows a block diagram of a cloud based system 400, according to an embodiment. In one embodiment, the system 400 comprises multiple cloud based environments 410 that each offer multiple services, application programming interfaces (APIs) 450 that are used by the cloud based environments 410 to communicate with a cloud environment 160 (e.g., a CE manufacturers cloud), the authorization server 170, an identity provider 430, and one or more electronic devices 120. In one embodiment, the electronic device 120 (or user of the electronic device) must be authenticated and the electronic device must be authorized in order to obtain services from the cloud based environments 410. In one embodiment, the authorization server installs credentials 440 (e.g., authentication and authorization elements, tokens, etc.) on the secure media 140 of the electronic device.

In one embodiment, authentication service for electronic device 120 includes the following. A service provider may authenticate the electronic device 120, a user of the electronic device 120, or both. In one embodiment, the electronic device 120 is authenticated to assure other eco-systems that they are communicating with a valid device. In one embodiment, the same secure media 140 based mechanism is also applicable for authenticating the user of the electronic device 120 to a set of web services. In one embodiment, an authorization service is used for authorizing a user of an electronic device 120 for a certain service offered by a cloud based eco-system (e.g., a cloud based environment 410) in the considered use cases.

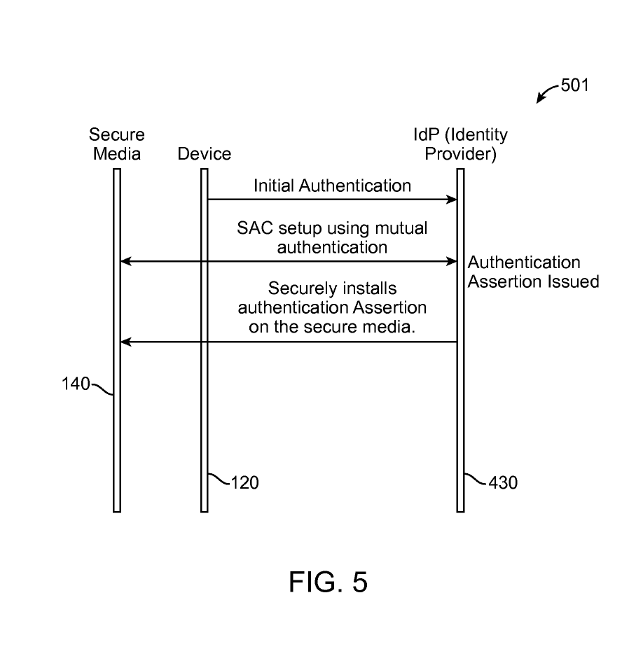

FIG. 5 shows a flow diagram 501 for initial installation of an authentication element (e.g., an authentication token, SAML assertion, etc.) in a secure media 140, according to an embodiment. In one embodiment, the cloud environment 160 (e.g., cloud-hub) provides an identity service so that a service provider does not need to separately authenticate the electronic device 120. In one embodiment, a single sign-on (SSO) based solution is used where the cloud environment 160 provides the device authentication service to the other cloud based eco-systems (e.g., cloud based environments 410). In one embodiment, the SSO term is originally used for authenticating a user to a set of web servers using the same user credentials. In one embodiment, the secure media 140 is used in the authentication loop.

In one embodiment, the electronic device 120 first authenticates with the identity provider 430 in the cloud environment 160 using a CE provider specific authentication mechanism. In one embodiment, the CE provider specific authentication may involve authentication of platform integrity among other things, such as firmware version number, etc. In one embodiment, the identity provider 430, after authenticating the electronic device 120, issues a SAML assertion (e.g., authentication token). In one embodiment, the identity provider 430 forwards/communicates the SAML assertion to the authorization server 170 for installation in the secure media 140. In one embodiment, the authorization server 170 sets up (e.g., initiates, arranges, etc.) an SAC to the secure media 140 in the device. In one embodiment, the authorization server 170 checks the credential assignment table in the certificate 300 and selects an unassigned PAD block for installing the SAML assertion. In one embodiment, the authorization server then stores the SAML assertion in the selected protected area PAD block of the certificate 300 in the secure media 140.

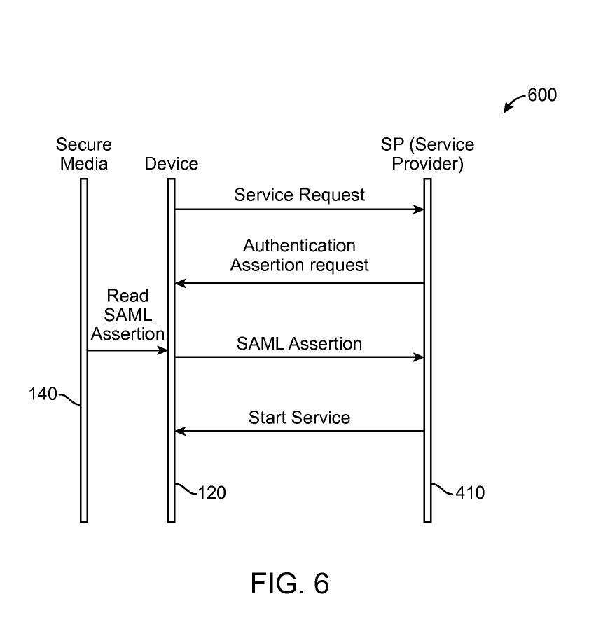

FIG. 6 shows a flow diagram of service authentication 600 using a secure media 140, according to an embodiment. In one embodiment, after the electronic device 120 initially is authenticated, the electronic device 120 requests service with a service request to a service provider 410. In one embodiment, after the service provider 410 receives the service request from the electronic device 120, the service provider 410 requests the authentication element (e.g., SAML assertion, authentication token, etc.) from the secure media 140 of the electronic device 120. In one embodiment, the authentication element is the retrieved from the certificate 300 of the secure media 140 (e.g., via a Get PAD instruction) and communicated to the service provider 410. In one embodiment, after the service provider 410 receives the authentication element from the secure media 140, the service provider starts service for authorization of the electronic device 120.

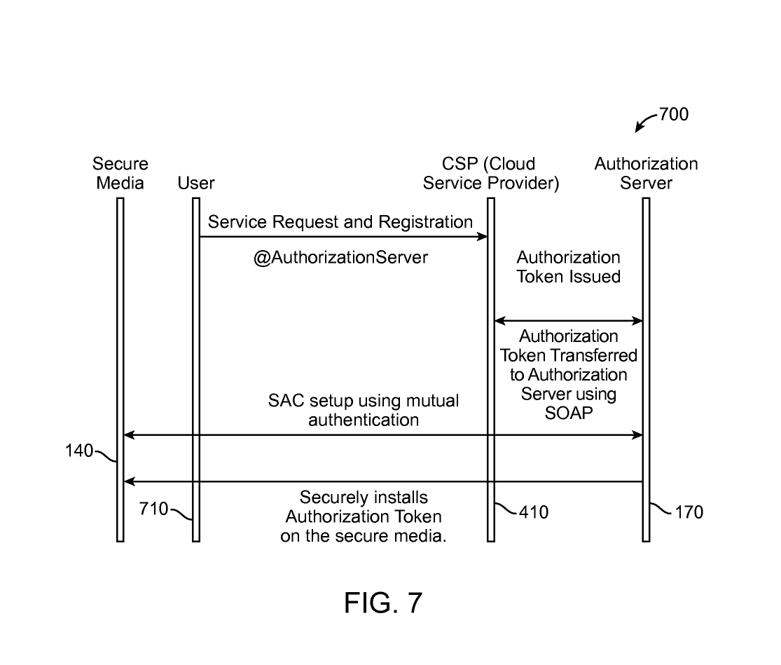

FIG. 7 shows a flow diagram 700 of installation of an authorization element (e.g., authorization token, etc.) using the secure media 140, according to an embodiment. In one embodiment, the cloud environment 160 provides a proxy authorization service by storing the authorization element in the secure media 140 on behalf of a cloud service provider of a cloud based environment 410. In one embodiment, the electronic device 120 (e.g., client) requests and registers for the service at the cloud service provider of a cloud based environment 410 and the service provider issues an authorization element. In one embodiment, the cloud service provider transfers the authorization element to the authorization server 170 at the cloud environment 160 using an application signaling protocol, such as simple object access protocol (SOAP), etc. In one embodiment, the authorization server sets up a SAC to the secure media 140 in the electronic device 120.

In one embodiment, the authorization server 170 acts as a remote host and checks the credential assignment table of the certificate 300 of the secure media 140 to select an unassigned PAD block for installing the credential (e.g., authorization element, authorization token, etc.). In one embodiment, the authorization server 170 stores the authorization element issued by the cloud service provider in the selected PAD block (e.g., a set PAD block 311) in the certificate 300 of the secure media 140.

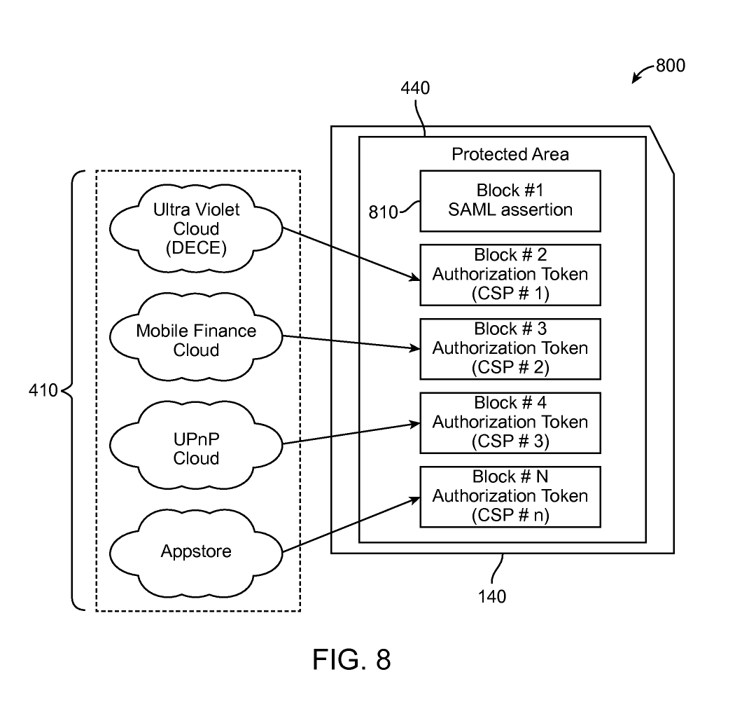

FIG. 8 shows a block diagram 800 of installation of credentials 440 of cloud service providers of cloud based environments 410 in the secure media 140, according to an embodiment. In one embodiment, the certificate 300 stores the credentials 440 in different blocks 810 on the secure media 140. In one embodiment, the credentials 440 may comprise SAML assertions, authorization elements or tokens, etc. In one embodiment, once the credentials 440 of the different cloud based service providers of the cloud based environments 410 are stored on the secure media 140, the device 120 does not need to communicate each and every time with a service provider for the electronic device 120 to be authenticated and authorized since the credentials may be retrieved directly from the secure media 140.

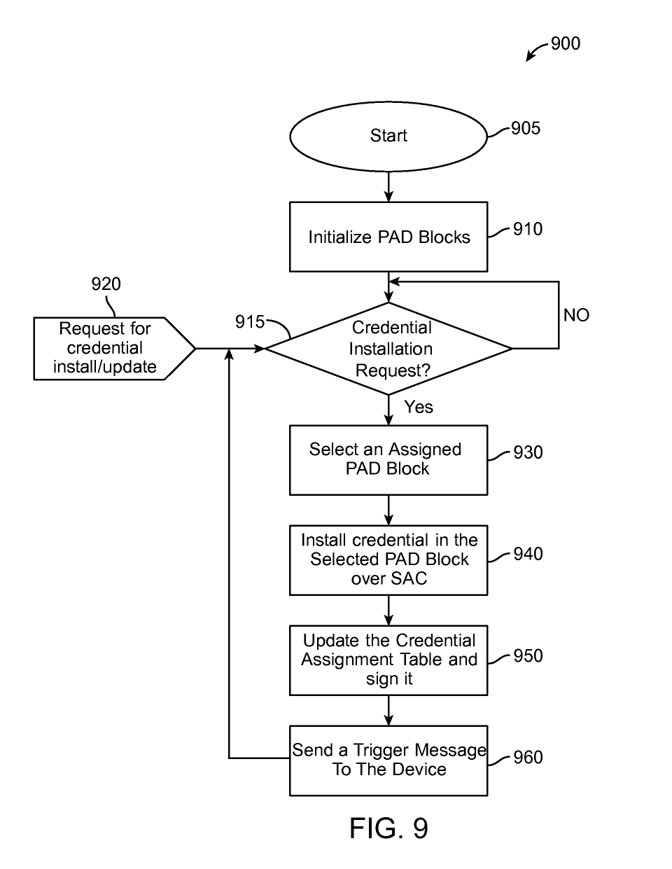

FIG. 9 shows a flowchart of a credential installation process by an authorization server to secure media, according to an embodiment. In one embodiment, flowchart 900 begins at block 905 where the authorization server 170 begins authorization of the electronic device 120 by setting up an SAC to the secure media 140. In one embodiment, in block 910 the authorization server 170 initializes PAD blocks is an assigned certificate 300 for the secure media 140. In one embodiment, in block 915, the authorization service waits for the credential installation request from either the identity provider 430 or one of the several eco-systems of a cloud based environment 410.

In one embodiment, if the credential installation process 900 does not receive a credential installation request, the credential installation process 900 remains in waiting. If the credential installation process 900 receives a credential installation request from block 920, in block 915 upon getting such a request the authorization server 170 checks the credential assignment table of the certificate 300 of the secure media 140 for an unassigned PAD block. In one embodiment, in block 930 the authorization server 170 selects an unassigned PAD block of the certificate 300 of the secure media 140. In one embodiment, in block 940 the authorization server 170 installs the credential in the selected PAD block over the SAC.

In one embodiment, in block 950 the authorization server updates the credential assignment table in the secure media 140 after the successful installation of the credential and signs it. In one embodiment, in block 960 the authorization server 170 sends a trigger message to the electronic device 120 (e.g., the local Host) to initiate acquisition of the updated credential assignment table by the electronic device 120. In one embodiment, the process 900 then goes back to block 915 and waits for another credential installation or update request.

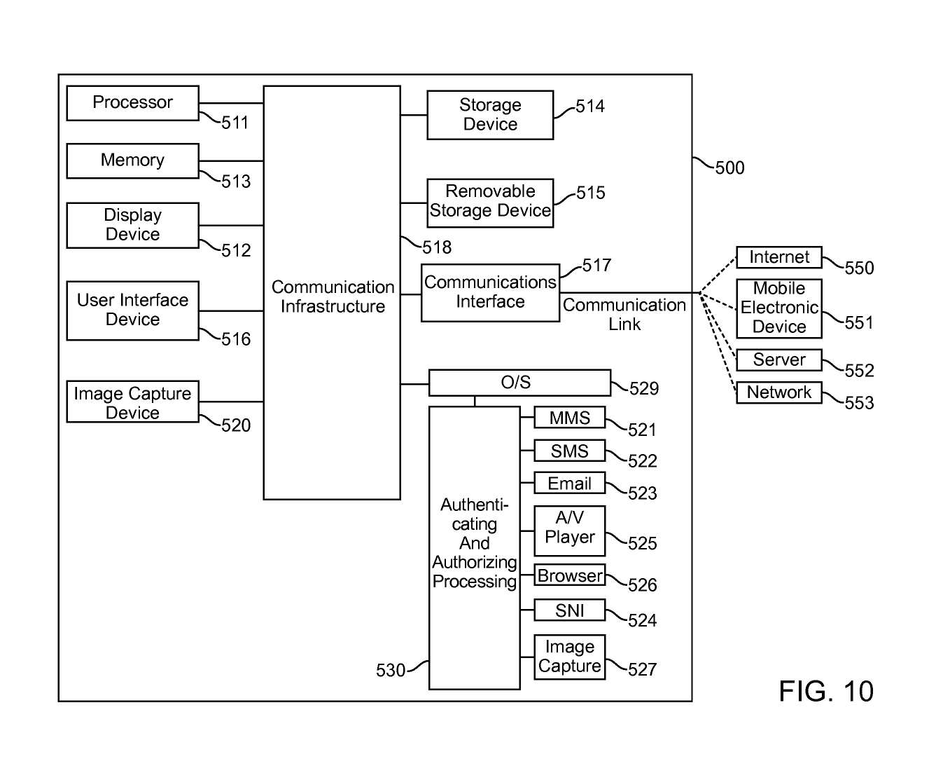

FIG. 10 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals to/from a plurality of sinks/sources, such as, the Internet 550, a mobile electronic device 551, a server 552, or a network 553, and may be implemented using wire or cable, fiber optics, a phone line, a cellular phone link, an radio frequency (RF) link, and/or other communication channels.

In one implementation, in a mobile wireless device such as a mobile phone, the system 500 further includes an image capture device such as a camera 127. The system 500 may further include application modules as image capture device module 520, MMS module 521, SMS module 522, email module 523, social network interface (SNI) module 524, audio/video (AV) player 525, web browser 526, image capture module 527, etc.

The system 500 further includes an authenticating and authorizing processing module 530 as described herein, according to an embodiment. In one implementation of the authenticating and authorizing processing module 530 along with an operating system 529 may be implemented as executable code residing in a memory of the system 500. In another embodiment, such modules are in firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor creates means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

1. A method comprising:
requesting authentication of an electronic device by a service provider in response to a request for service by the electronic device;
providing an authentication element to the service provider via a secure media of the electronic device;
in response to the request for service, an authorization server providing proxy authorization for the service provider by receiving an authorization element from the service provider and installing the authorization element on the secure media; and
upon authenticating and authorizing the electronic device using the secure media, accessing the requested service.

2. The method of claim 1, further comprising:
performing initial authentication of the electronic device with an identity provider;
upon initial authentication of the electronic device, issuing the authentication element from the identity provider to the authorization server and installing the authentication element on the secure media of the electronic device.

3. The method of claim 2, wherein the secure media is one of embedded in the electronic device or removable from the electronic device.

4. The method of claim 3, wherein storage of the authentication element and the authorization element on the secure media provide credentials required for accessing cloud based services offered by different eco-systems.

5. The method of claim 1, wherein the authentication element comprises a security assertion markup language (SAML) assertion.

6. The method of claim 5, wherein the initial authentication further comprises:
providing the SAML assertion to the authorization server for installation in the secure media via a secure channel;
checking a credential assignment table and selecting an unassigned protected area data (PAD) block for installing the SAML assertion in the credential assignment table of the secure media; and
storing the SAML assertion in the selected PAD block in the credential assignment table of the secure media.

7. The method of claim 6, wherein the authorization server comprises read and write privileges to the credential assignment table of the secure media, and the electronic device only comprises read privileges to the credential assignment table of the secure media.

8. The method of claim 7, wherein receiving the authorization element to the service provider further comprises:
transferring the authorization element to the authorization server using an application signaling protocol;
initializing a secure channel by the authorization server for communicating with the secure media;
checking the credential assignment table and selecting an unassigned PAD block for installing the authorization element in the credential assignment table of the secure media; and
storing the authorization element issued by the service provider in the selected PAD block in the credential assignment table of the secure media.

9. The method of claim 8, wherein the authorization server manages the credential assignment table of the secure media.

10. The method of claim 9, wherein the electronic device comprises one of a mobile phone device, a camera device, a tablet computing device, a laptop computing device and a personal computer (PC) device.

11. A system comprising:
an electronic device;
a secure media device coupled to the electronic device;
an authorization server coupled to a plurality of cloud based service providers, the authorization server providing proxy authorization for a requested service from one of the service providers by receiving an authorization token from the service provider and installing the authorization token on the secure media, wherein upon the selected service provider authenticating and authorizing the electronic device, the electronic device accesses the requested service.

12. The system of claim 11, further comprising an identity provider that performs initial authentication of the electronic device and issues an authentication token to the authorization server that installs the authentication token on the secure media.

13. The system of claim 12, wherein the secure media is one of a device embedded in the electronic device or a device that is removably coupled to the electronic device.

14. The system of claim 13, wherein storage of the authentication token and the authorization token on the secure media provide credentials required for accessing cloud based services offered by different eco-systems.

15. The system of claim 12, wherein the authentication token comprises a security assertion markup language (SAML) assertion.

16. The system of claim 15, wherein the identity provider provides the SAML assertion to the authorization server, the authorization server initializes a secure authenticated channel (SAC) for communicating with the secure media, checks a credential assignment table in the secure media, selects an unassigned protected area data (PAD) block for installing the SAML assertion in the credential assignment table and stores the SAML assertion in the selected PAD block in the credential assignment table.

18-30. (canceled)

31. The system of claim 16, wherein the one service provider transfers the authorization token to the authorization server using an application signaling protocol, and the authorization server initializes an SAC with the secure media, checks the credential assignment table, selects an unassigned PAD block for installing the authorization token in the credential assignment table, and stores the authorization token issued by the one service provider in the selected PAD block in the credential assignment table.

32. The system of claim 31, wherein the electronic device comprises one of a mobile phone device, a camera device, a tablet computing device, a laptop computing device and a personal computer (PC) device.

33. A non-transitory computer-readable medium having instructions which when executed on a computer perform a method comprising:
requesting authentication of the electronic device by a service provider in response to a request for service by the electronic device;
providing an authentication token to the service provider via a secure media of the electronic device;
in response to the request for service, an authorization server providing proxy authorization for the service provider by receiving an authorization token from the service provider and installing the authorization token on the secure media; and
upon authenticating and authorizing the electronic device using the secure media, accessing the requested service.

34. The medium of claim 33, further comprising:
performing initial authentication of the electronic device with an identity provider;
upon initial authentication of the electronic device, issuing the authentication token from the identity provider to the authorization server and installing the authentication token on the secure media of the electronic device.

35. The medium of claim 34, wherein the secure media is one of embedded in the electronic device or removable from the electronic device, and storage of the authentication token and the authorization token on the secure media provide credentials required for accessing cloud based services offered by different eco-systems.

36. The medium of claim 33, wherein the authentication token comprises a security assertion markup language (SAML) assertion, and the initial authentication further comprises:
providing the SAML assertion to the authorization server for installation in the secure media via a secure channel;
checking a credential assignment table and selecting an unassigned protected area data (PAD) block for installing the SAML assertion in the credential assignment table of the secure media; and
storing the SAML assertion in the selected PAD block in the credential assignment table of the secure media.

37. The medium of claim 36, wherein the authorization server comprises read and write privileges to the credential assignment table of the secure media, and the electronic device only comprises read privileges to the credential assignment table of the secure media.

38. The medium of claim 37, wherein receiving the authorization token from the service provider further comprises:
transferring the authorization token from the service provider to the authorization server using an application signaling protocol;
initializing a secure channel by the authorization server for communicating with the secure media;
checking the credential assignment table and selecting an unassigned PAD block for installing the authorization token in the credential assignment table of the secure media; and
storing the authorization token issued by the service provider in the selected PAD block in the credential assignment table of the secure media.

39. The medium of claim 38, wherein the authorization server manages the credential assignment table of the secure media.

40. The medium of claim 38, wherein the electronic device comprises one of a mobile phone device, a camera device, a tablet computing device, a laptop computing device and a personal computer (PC) device.

41. A method comprising:
providing an authentication token to a service provider from a secure media of an electronic device;
providing proxy authorization for the service provider by an authorization server that receives an authorization token from the service provider and installs the authorization token on the secure media; and
using the authentication token and the authorization token from the secure media for accessing a requested service.

42. The method of claim 41, further comprising:
performing initial authentication of the electronic device with an identity provider;
upon initial authentication of the electronic device, issuing the authentication token from the identity provider to the authorization server and installing the authentication token on the secure media of the electronic device, wherein the authentication token comprises a security assertion markup language (SAML) assertion, and the initial authentication further comprises:
providing the SAML assertion to the authorization server for installation in the secure media via a secure channel;
checking a credential assignment table and selecting an unassigned protected area data (PAD) block for installing the SAML assertion in the credential assignment table of the secure media; and
storing the SAML assertion in the selected PAD block in the credential assignment table of the secure media.

43. The method of claim 42, wherein receiving the authorization token from the service provider further comprises:
transferring the authorization token to the authorization server using an application signaling protocol;
initializing a secure channel by the authorization server for communicating with the secure media;
checking the credential assignment table and selecting an unassigned PAD block for installing the authorization token in the credential assignment table of the secure media; and
storing the authorization token issued by the service provider in the selected PAD block in the credential assignment table of the secure media,
wherein the secure media is one of embedded in the electronic device or removable from the electronic device, and storage of the authentication token and the authorization token on the secure media provide credentials required for accessing cloud based services offered by different eco-systems.
